(19) United States
(12) Patent Application Publication
(10) Pub. No.: US 2025/0353428 A1
(43) Pub. Date: Nov. 20, 2025

(54) CONTROL DEVICE, VEHICLE, AND CONTROL METHOD

(71) Applicant: HONDA MOTOR CO., LTD., Tokyo (JP)

(72) Inventors: Kazunari SATO, Wako-shi (JP); Yuta SENOKUCHI, Wako-shi (JP); Toraki IWAMARU, Wako-shi (JP)

(21) Appl. No.: 19/282,240

(22) Filed: Jul. 28, 2025

Related U.S. Application Data
(63) Continuation of application No. PCT/JP2024/007737, filed on Mar. 1, 2024.

(30) Foreign Application Priority Data
Mar. 16, 2023 (JP) 2023-042276

(51) Int. Cl. B60Q 1/34

(52) U.S. Cl. CPC B60Q 1/346

(57) ABSTRACT

A control device, configured to control activation of a direction indicator provided on a vehicle, detects a predetermined signal corresponding to a start of the activation of the direction indicator, acquires a value corresponding to a vehicle speed of the vehicle, activates, after determining that the value corresponds to a first vehicle speed and detecting the predetermined signal, the direction indicator until a first time elapses, and activates, when determining that the value corresponds to a second vehicle speed greater than the first vehicle speed, the direction indicator until a second time shorter than the first time elapses after the predetermined signal is detected.

### CROSS-REFERENCE TO RELATED APPLICATION(S)

This application is a continuation of International Patent Application No. PCT/JP2024/007737 filed on Mar. 1, 2024, which claims priority to and the benefit of Japanese Patent Application No. 2023-042276 filed on Mar. 16, 2023, the entire disclosures of which are incorporated herein by reference.

### TECHNICAL FIELD

The present invention relates to a control device, a vehicle, and a control method.

### BACKGROUND ART

A control device that automatically turns off (cancels) a direction indicator (blinker) based on a speed of a vehicle has been proposed (Patent Literature 1). In Patent Literature 1, when the speed of the vehicle is greater than a predetermined speed, the operation of the direction indicator is automatically canceled after the vehicle travels a predetermined time or a predetermined distance.

### CITATION LIST

### Patent Literature

PTL 1: Japanese Patent Laid-Open No. 2014-162462

### SUMMARY OF INVENTION

### Technical Problem

Here, a control device that controls the direction indicator does not stop the activation until the vehicle has traveled the predetermined time or the predetermined distance, and thus, depending on the situation in which the vehicle travels, the operation time of the direction indicator can be too long or too short.

An object of the present invention is to provide a technique for appropriately controlling a direction indicator according to a situation in which a vehicle travels.

### Solution to Problem

According to the present invention, there is provided a control device configured to control activation of a direction indicator provided on a vehicle, wherein
the control device performs:
detecting a predetermined signal corresponding to a start of the activation of the direction indicator;
acquiring a value corresponding to a vehicle speed of the vehicle at a predetermined time interval;
activating, after determining that the value corresponds to a first vehicle speed and detecting the predetermined signal, the direction indicator until a first time elapses; and
activating, when determining that the value corresponds to a second vehicle speed greater than the first vehicle speed, the direction indicator until a second time shorter than the first time elapses after the predetermined signal is detected,
after detecting the predetermined signal, determining that the value corresponds to the first vehicle speed, and starting the activation of the direction indicator and before stopping the activation of the direction indicator and when determining the value corresponds to the second vehicle speed and that the vehicle has accelerated,
determining a first ratio of the second vehicle speed to the first vehicle speed,
stopping, when the first ratio is equal to or greater than a first threshold, the activation of the direction indicator according to elapse of a third time shorter than the second time,
stopping, when the first ratio is equal to or greater than a second threshold greater than the first threshold, the activation of the direction indicator when a fourth time shorter than the third time elapses.

### Advantageous Effects of Invention

According to the present invention, it is possible to provide a technique for appropriately controlling a direction indicator according to a situation in which a vehicle travels.

### BRIEF DESCRIPTION OF DRAWINGS

Other features and advantages of the present invention will be apparent from the following description taken in conjunction with the accompanying drawings. Note that the same reference numerals denote the same or like components throughout the accompanying drawings.

FIG. 1 is a side view of a vehicle according to the present embodiment.

FIG. 2 is a configuration diagram of a control system according to the present embodiment.

FIG. 3 is a diagram illustrating an example of processing to be performed by an ECU according to the present embodiment.

FIG. 4A is a diagram illustrating a correspondence between a vehicle speed and an activation time according to the present embodiment.

FIG. 4B is a diagram illustrating a correspondence between a change rate of vehicle speed and a multiplier of activation time according to the present embodiment.

FIG. 5A is a diagram illustrating a modification of a correspondence between a vehicle speed and an activation time.

FIG. 5B is a diagram illustrating a modification of a correspondence between a vehicle speed and an activation time.

FIG. 6 is a diagram illustrating a modification of a correspondence between a change rate of vehicle speed and a multiplier of activation time.

FIG. 7 is a diagram illustrating a modification of processing to be performed by the ECU according to the present embodiment.

### DESCRIPTION OF EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### EMBODIMENT

### (Hardware Configuration)

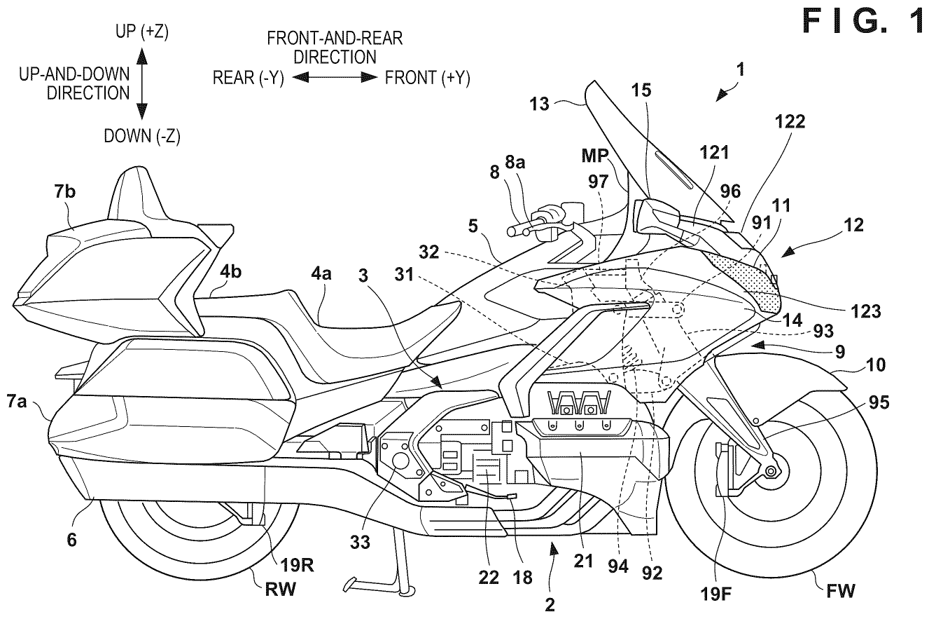

FIG. 1 is a right side view of a straddle type vehicle 1 according to the present embodiment. The straddle type vehicle 1 is a tourer-type two-wheeled motorcycle suitable for long distance traveling, but the present invention is applicable to various straddle type vehicles including other types of two-wheeled motorcycles and is also applicable to an electric vehicle using a motor as a drive source in addition to a vehicle using an internal combustion engine as a drive source. Hereinafter, the straddle type vehicle 1 will be referred to as a vehicle 1, in some cases.

The vehicle 1 includes a power unit 2 between a front wheel FW and a rear wheel RW. In the present embodiment, the power unit 2 includes a horizontally opposed six-cylinder engine 21 and a transmission 22. A driving force of the transmission 22 is transmitted to the rear wheel RW via a drive shaft (not illustrated) to rotate the rear wheel RW.

The power unit 2 is supported by a vehicle body frame 3. The vehicle body frame 3 includes a pair of left and right main frames 31 extending in X direction. A fuel tank 5 and an air cleaner box (not illustrated) are disposed above the main frames 31. A meter panel MP that displays various types of information to a rider is provided in front of the fuel tank 5.

At front end portions of the main frames 31, a head pipe 32, which rotatably supports a steering shaft (not illustrated) to be rotated by a handlebar 8, is provided. A pair of left and right pivot plates 33 are provided at a rear end portion of the main frames 31. Lower end portions of the pivot plates 33 and the front end portions of the main frames 31 are connected with each other by a pair of left and right lower arms (not illustrated), and the power unit 2 is supported by the main frames 31 and the lower arms. At the rear end portions of the main frames 31, a pair of left and right seat rails (not illustrated) extending rearward is provided, and the seat rails support a seat 4a on which the rider is seated, a seat 4b on which a passenger is seated, a rear trunk 7b, and the like.

A front end portion of a rear swing arm (not illustrated) extending in the front-and-rear direction is swingably supported by the pivot plates 33. The rear swing arm is swingable in the up-and-down direction, and the rear wheel RW is supported on its rear end portion. An exhaust muffler 6, which muffles exhaust of the engine 21, extends in X direction on a lower lateral side of the rear wheel RW. On upper lateral sides of the rear wheel RW, left and right saddlebags 7a are respectively provided.

At the front-end portions of the main frames 31, a front suspension mechanism 9 that supports the front wheel FW is formed. The front suspension mechanism 9 includes an upper link 91, a lower link 92, a fork support body 93, a cushion unit 94, and a pair of left and right front forks 95.

The upper link 91 and the lower link 92 are each disposed at the front ends of the main frames 31 with a space therebetween in the up-and-down direction. Rear end portions of the upper link 91 and the lower link 92 are each swingably connected to the front ends of the main frames 31. Front ends of the upper link 91 and the lower link 92 are each swingably connected to the fork support body 93. The upper link 91 and the lower link 92 each extend in the front-and-rear direction and are disposed substantially in parallel.

The cushion unit 94 has a structure in which a shock absorber is inserted into a coil spring, and an upper end portion of the cushion unit 94 is swingably supported by the main frames 31. A lower end portion of the cushion unit 94 is swingably supported by the lower link 92.

The fork support body 93 has a tubular shape, and is inclined rearward. A front end portion of an upper link 21 is rotatably coupled with an upper front portion of the fork support body 93. A front end portion of the lower link 92 is rotatably coupled with a lower rear portion of the fork support body 93.

A steering shaft 96 is supported by the fork support body 93 so as to be rotatable around the axis of the steering shaft 96. The steering shaft 96 includes a shaft portion (not illustrated) that passes through the fork support body 93. A bridge (not illustrated) is provided at the lower end portion of the steering shaft 96, and the pair of left and right front forks 95 is supported by the bridge. The front wheel FW is rotatably supported by the front forks 95. An upper end portion of the steering shaft 96 is coupled with a steering shaft (not illustrated) to be rotated by the handlebar 8 via a link 97. The steering shaft 96 is rotated by the steering of the handlebar 8, and the front wheel FW is steered. An upper part of the front wheel FW is covered with a fender 10, and the fender 10 is supported by the front forks 95.

The vehicle 1 includes a brake device 19F that brakes the front wheel FW and a brake device 19R that brakes the rear wheel RW, and the brake devices 19F and 19R are configured to be activated by the operation of a brake lever 8a or a brake pedal 18 by the rider. The brake devices 19F and 19R are, for example, disc brakes.

In a front of the vehicle 1, a headlight unit 11 that emits light ahead of the vehicle 1 is disposed. The headlight unit 11 according to the present embodiment is a headlight unit of a binocular type including symmetrically a light irradiation unit 11R on a right side and a light irradiation unit 11L on a left side. However, a headlight unit of a monocular type or a trinocular type, or a headlight unit of an asymmetrical binocular type can also be adopted.

The front portion of the vehicle 1 is covered with a front cover 12, and side portions on the front side of the vehicle 1 are covered with a pair of left and right side covers 14. A screen 13 is disposed above the front cover 12. The screen 13 is a windshield that reduces wind pressure applied to the rider during traveling and is formed of, for example, a transparent resin member. A pair of left and right side mirror units 15 is disposed on lateral sides of the front cover 12. The side mirror units 15 support side mirrors (not illustrated) for the rider to visually recognize the rear side.

The front cover 12 includes cowl members, and the cowl members constitute a front cowl. A cowl member 121 extends in a Y direction to constitute a main body of the front cover 12, and a cowl member 122 constitutes an upper portion of the cowl member 121. A cowl member 123 is disposed to be spaced apart from the cowl member 121 in a downward direction.

An opening for exposing the headlight unit 11 is formed between the cowl member 121 and the cowl member 123 and between the pair of left and right side covers 14, the cowl member 121 defines an upper edge of the opening, the cowl member 123 defines a lower edge thereof, and the side covers 14 define left and right side edges thereof.

### <Control System of Direction Indicator>

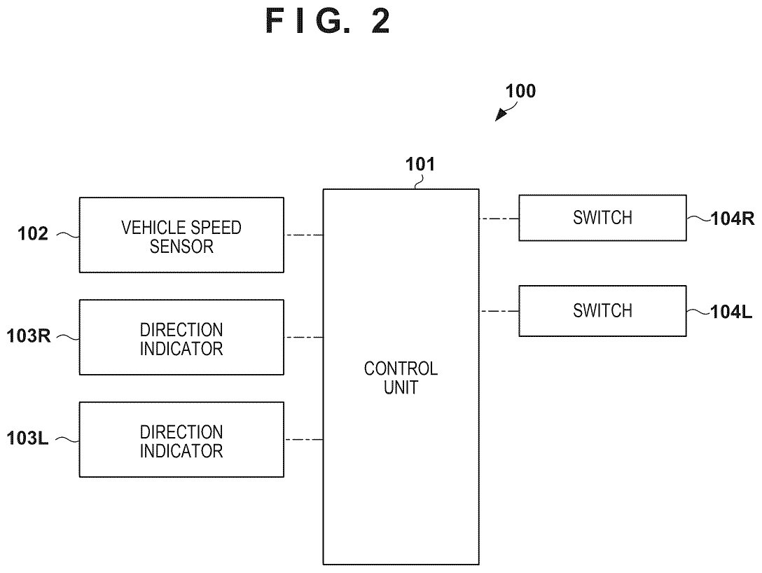

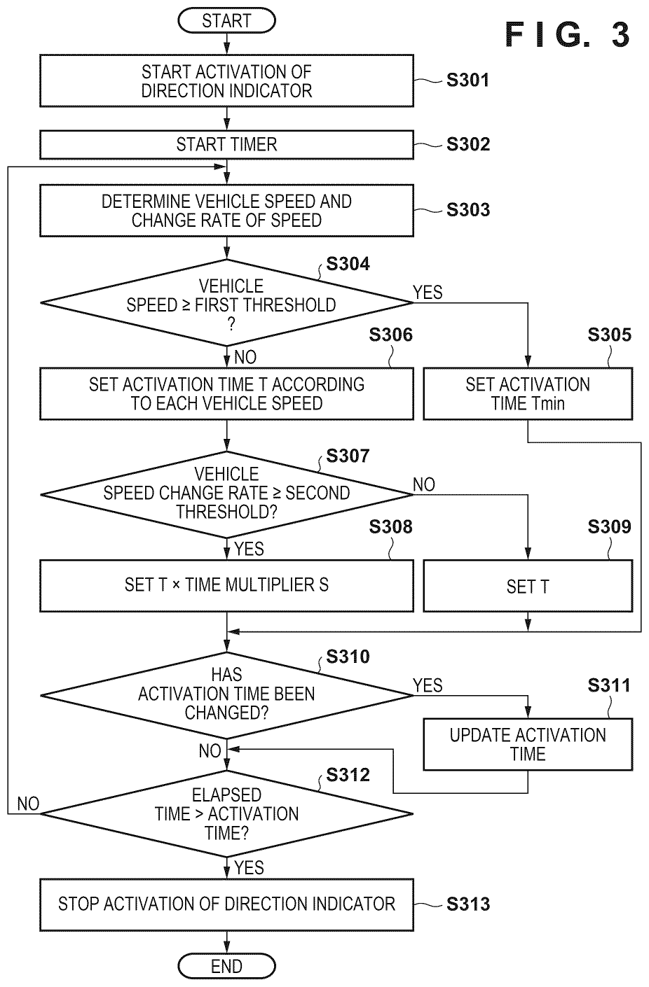

FIG. 2 is a block diagram of a control system 100 of a direction indicator of the vehicle 1, and only necessary elements are illustrated in relation to description to be described later. A control unit (ECU) 101 controls lighting devices (a headlight, a taillight, and the like) including direction indicators 103R and 103L (hereinafter, can be referred to as a direction indicator 103 without distinction). The ECU 101 is a control device including one or more processors represented by a CPU, a storage device such as semiconductor memory, an input/output interface or a communication interface with an external device, or the like. The storage device stores programs to be executed by the processors, data to be used by the processors for processing, and the like. The ECU 101 may include a plurality of processors, storage devices, interfaces, and the like. Note that the number of ECUs 101 and functions to be assigned can be designed as appropriate. In an example, the ECU 101 may output a control signal to the direction indicator 103 via a relay element such as a blinker relay. Furthermore, in an example, the ECU 101 may be provided integrally with the relay element, or as a control element in the relay element. Alternatively, the function of the ECU 101 may be implemented by a plurality of control devices. In such a case, processing to be performed by the control device according to the present embodiment, which will be described later with reference to FIG. 3, is only required to be performed by the plurality of control devices. It is possible to design which control device performs which processing as appropriate.

The direction indicator 103 is described as being provided on the side portion of the headlight unit 11. Note that the direction indicator 103 may be provided separately from the headlight unit 11, and the installation position can be changed as appropriate. In addition, a plurality of direction indicators 103R and 103L may be provided in the headlight unit 11 and the taillight (not illustrated).

A vehicle speed sensor 102 is a pulse sensor that detects the rotation of a rear wheel axle or an output shaft, such as a swing unit (not illustrated) or a final reduction (not illustrated) gear. In the present embodiment, the ECU 101 will be described based on the assumption that the ECU 101 identifies number of rotations of the wheel axle or the output shaft that transmits power to the wheels, based on a value acquired from the vehicle speed sensor 102, and determines the vehicle speed based on the prescribed outer diameter of the wheel. However, any sensor can be used as the vehicle speed sensor 102 as long as the sensor outputs a value corresponding to the vehicle speed. The vehicle speed sensor 102 may be an optical sensor or a magnetic sensor. In addition, the vehicle speed sensor 102 may be provided on the front wheel.

Switches 104R and 104L (hereinafter, can be referred to as a switch 104 without distinction) are provided on the handlebar 8 or near the handlebar 8, and light or blink the direction indicators 103R and 103L according to an operation of a driver, who is a user. In the following description, lighting and blinking of the direction indicator 103 will be referred to as “activation” without distinction. Note that the activation of the direction indicator 103 can be stopped by operating the switch 104 again or by operating a separate switch (not illustrated). In the present embodiment, the control of the activation of the direction indicator 103 includes lighting or blinking the direction indicator 103 for a predetermined time and automatically terminating the lighting or blinking after a predetermined time elapses. In addition, as will be described later, the control of the activation of the direction indicator 103 may include the control system 100 changing a blinking pattern of the direction indicator 103, a color of a light to be lit, and the like, while the driver operates to stop the activation of the direction indicator 103, keeping the direction indicator 103 lit or blinking.

Patent Literature 1 has proposed a technique for automatically terminating activation of a direction indicator after a predetermined distance has been traveled or a predetermined time has elapsed.

A first example is a case where the activation of the direction indicator is started by operating the switch while the vehicle is traveling at a predetermined speed or greater before reaching a curve, such as an intersection. In such a case, the vehicle can decelerate or stop to wait for a preceding vehicle or a pedestrian passing through a crosswalk, and a predetermined time or more can elapse before the vehicle passes through the curve. In such a case, the operation of the direction indicator can be canceled before the vehicle passes through the curve, which may require the driver to operate the switch again.

A second example is a case where, when the vehicle is traveling at a predetermined speed or greater on a highway or the like, the switch is operated for lane change to start the activation of the direction indicator. In such a case, the vehicle can travel a predetermined distance or more before completing the lane change, and the activation of the direction indicator can be stopped, which may require the driver to operate the switch again.

A third example is a case where the driver operates the switch to start lighting the direction indicator when the vehicle is turning at a predetermined angle on a curve with a different radius of curvature at a speed lower than a predetermined speed. In such a case, the vehicle does not stop the activation of the direction indicator unless the vehicle travels a predetermined distance. For this reason, in a case of a curve with a large radius of curvature, the activation of the direction indicator can be stopped before turning on the curve.

In this manner, there is a problem that the time for which the direction indicator is activated is not appropriately set depending on the situation in which the vehicle is traveling. The control system 100 according to the present embodiment appropriately controls the activation of the direction indicator by performing processing described below.

### Processing Example

Next, an example of processing to be performed by the ECU 101 according to the present embodiment will be described with reference to FIG. 3. The processing illustrated in FIG. 3 is performed when the ECU 101 detects that the switch 104 has received an operation from a user, such as a driver, to activate the direction indicator 103. The processing illustrated in FIG. 3 is implemented by one or more processors of the ECU 101 executing a program stored in a memory.

In S301, the ECU 101 starts the activation of the direction indicator 103. That is, the direction indicator 103 starts lighting or blinking. For example, in S301, the ECU 101 transmits an activation request signal to the direction indicator 103. In another example, when outputting a signal to the direction indicator 103 continuously or at a predetermined time interval, the ECU 101 changes the value of the signal to a value for starting the activation. In S302, the ECU 101 starts the operation of a timer that controls the activation of the direction indicator 103.

In S303, the ECU 101 determines a vehicle speed of the vehicle 1 and a change rate of the vehicle speed based on the value acquired from the vehicle speed sensor 102. When the processing in S303 is performed first after the processing in FIG. 3 is started, the ECU 101 does not store the previous vehicle speed, and therefore, the change rate of the vehicle speed may not be determined, or the change rate of the vehicle speed may be set to a predetermined number such as zero. Note that, in an example, the ECU 101 may acquire a value corresponding to the change rate of the vehicle speed from an acceleration sensor or the like, and determine the change rate of the vehicle speed based on the value.

In S304, the ECU 101 determines whether the vehicle speed of the vehicle 1 determined in S303 is equal to or greater than a predetermined threshold (first threshold). When the vehicle speed is equal to or greater than the first threshold (YES in S304), the ECU 101 according to the present embodiment sets an activation time Tmin in such a manner that the direction indicator 103 is activated until the time Tmin elapses (S305). When the vehicle speed is less than the first threshold (NO in S304), a different activation time T is set according to the range of the vehicle speed (S306).

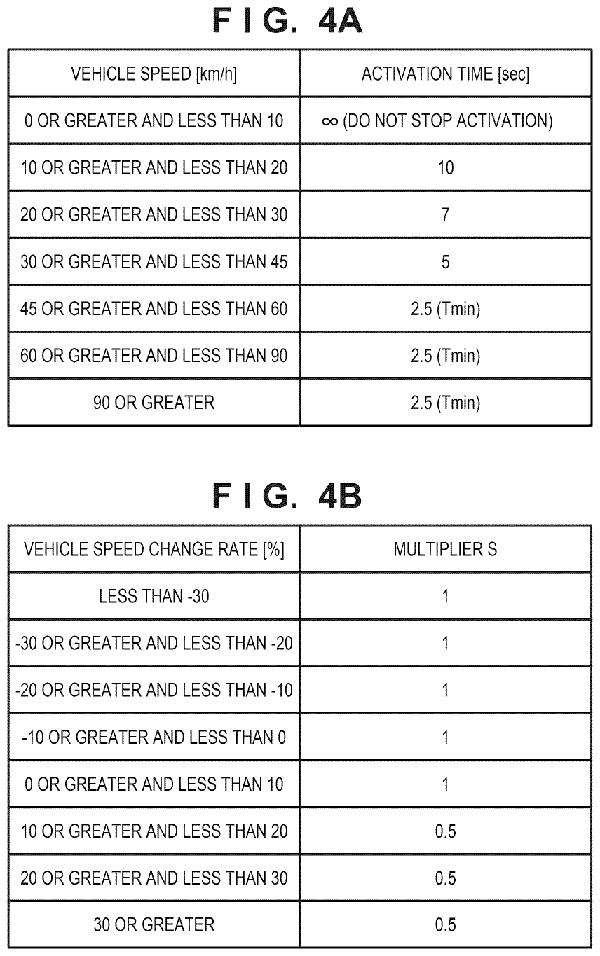

Here, a correspondence between the speed and the activation time set by the ECU 101 will be described with reference to FIG. 4A.

As illustrated in FIG. 4A, the ECU 101 sets the activation time to infinity when the vehicle speed is 0 km/h or greater and less than 10 km/h. That is, when the vehicle speed is 0 km/h or greater and less than 10 km/h, the activation time is only required to be set so to not to stop the activation, and an activation time may be a sufficiently large value. For example, it may be a predetermined value, such as 36000 seconds. When the vehicle speed is 10 km/h or greater and less than 20 km/h, the ECU 101 sets the activation time to 10 seconds. When the vehicle speed is 20 km/h or greater and less than 30 km/h, the ECU 101 sets the activation time to 7 seconds. When the vehicle speed is 30 km/h or greater and less than 45 km/h, the ECU 101 sets the activation time to 5 seconds. When the vehicle speed is 45 km/h or greater, the ECU 101 sets the activation time to 2.5 seconds.

In this manner, by activating the direction indicator 103 for a predetermined length of time even in a case where the vehicle speed is sufficiently high, it is possible to prevent the activation time of the direction indicator 103 from being insufficient while the vehicle 1 is traveling at the predetermined vehicle speed or greater, as described above with reference to the second example.

In addition, by setting the activation time of the direction indicator 103 to be long in a case where the vehicle speed is low, it is possible to prevent the activation time from being insufficient due to the activation of the direction indicator 103 automatically stopping when the vehicle 1 is traveling at a low speed or stopped to turn right or left.

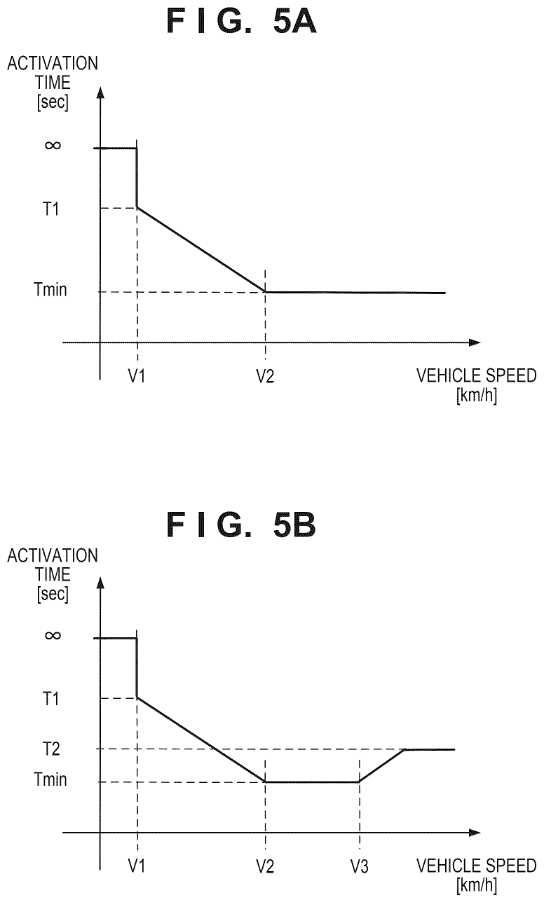

Note that, in the example of FIG. 4A, the description assumes that the activation time is assigned to each range of vehicle speed, like a staircase function. However, different activation times may be set, for example, as illustrated in FIGS. 5A and 5B.

In FIG. 5A, when the vehicle speed is less than V1, the activation time is set to infinity, and when the vehicle speed is V1 or greater and less than V2, the activation time is set in such a manner that the values of T1 to Tmin become shorter as the vehicle speed becomes faster. In the example of FIG. 5A, the vehicle speed and the activation time are expressed by a linear function, but a quadratic function or another function may be used. In such a case, the ECU 101 can identify a lighting standby time by substituting the vehicle speed into a predetermined function within the range of the predetermined vehicle speed. When the vehicle speed is V2 or greater, the activation time is set to Tmin. In FIG. 5B, in addition to FIG. 5A, when the vehicle speed is V3 or greater, an activation time greater than Tmin is set. That is, within the range of the predetermined vehicle speed, it is only required to provide a range of vehicle speed in which the activation time is set to be longer as the vehicle speed is lower.

Subsequent to the processing in S306, the ECU 101 determines whether a vehicle speed change rate is equal to or greater than a predetermined threshold (second threshold) (S307). The ECU 101 according to the present embodiment determines that there is a high possibility that an event, such as a left or right turn or a lane change, is terminated when the vehicle 1 is accelerating, and shortens the activation time of the direction indicator 103. Therefore, the second threshold is set to 10%, for example. When the processing in FIG. 3 is started and the vehicle speed change rate has not been set, that is, when the processing in FIG. 3 is started and the processing in S307 is performed first, the vehicle speed change rate is set to 1 time.

Here, as illustrated in FIG. 4B, an example of setting of the vehicle speed change rate and a multiplier S of the activation time according to the present embodiment will be described. As illustrated in FIG. 4B, the multiplier S is set to 0.5 times when the vehicle speed change rate is 10% or greater, and is set to 1 time when the vehicle speed change rate is less than 10%. For example, when the vehicle speed is 25 km/h and the vehicle speed change rate is 15%, the activation time is set to 7×0.5=3.5 seconds. As a result, the activation time can be shortened when the acceleration of the vehicle 1 is equal to or greater than a predetermined value.

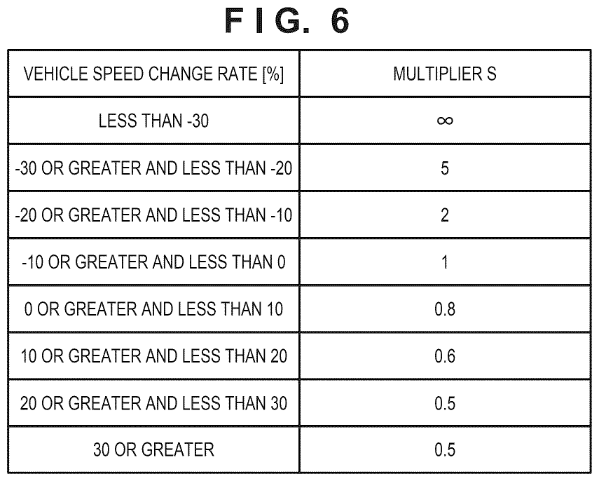

Note that, in the example of FIG. 4B, the description assumes that the multiplier S is 1 or 0.5. However, as illustrated in FIG. 6, three or more kinds of values may be set for the multiplier S.

In FIG. 6, the multiplier is ∞ when the vehicle speed change rate is less than −30%, is 5 when the vehicle speed change rate is −30% or greater and less than −20%, is 2 when the vehicle speed change rate is −20% or greater and less than −10%, is 1 when the vehicle speed change rate is −10% or greater and less than 0%, is 0.8 when the vehicle speed change rate is 0% or greater and less than 10%, is 0.6 when the vehicle speed change rate is 10% or greater and less than 20%, and is 0.5 when the vehicle speed change rate is 20% or greater. In this manner, when different multipliers are set according to the range of the vehicle speed change rate, the processing in S307 may be omitted, and after the activation time T may be set to each vehicle speed, the activation time multiplier S may be read according to the vehicle speed change rate, and TxS may be set as the activation time.

Note that, in the example of FIG. 6, a smaller multiplier S is set as the vehicle speed change rate is larger. However, when the acceleration is large, the vehicle 1 can be accelerating due to lane merging or the like. Therefore, the value can be changed as appropriate by, for example, setting the multiplier S to 0.7 when the vehicle speed change rate is 30% or greater. In addition, the range of the vehicle speed change rate can also be changed as appropriate.

When the vehicle speed change rate is equal to or greater than the second threshold (YES in S307), the ECU 101 sets a value (TxS) obtained by correcting the activation time T with the multiplier S set in S306 as the activation time (S308). On the other hand, when the vehicle speed change rate is less than the second threshold (NO in S307), the ECU 101 does not change the activation time from the value set in S306 (S309).

Subsequent to S305, S308, or S309, the ECU 101 determines whether the activation time has been changed (S310). When the activation time has been changed (YES in S310), the ECU 101 updates the activation time (S311). When the activation time has not been changed (NO in S310) or subsequent to S311, the ECU 101 determines whether an elapsed time from the start of the activation of the direction indicator 103 has exceeded the activation time based on a value of the timer (S312). When the elapsed time from the start of the activation of the direction indicator 103 has not been exceeded the activation time (NO in S312), the ECU 101 returns the processing to S303. In this manner, by repeating the determination of the vehicle speed and the setting of the activation time of the direction indicator 103 at a predetermined time interval, it is possible to appropriately set the activation time following the change in the vehicle speed.

When determining based on the value of the timer that the elapsed time from the start of the activation of the direction indicator 103 has exceeded the activation time (YES in S312), the ECU 101 advances the processing to S313 and stops the activation of the direction indicator 103. In S313, the ECU 101 outputs a stop request signal to the direction indicator. In another example, the ECU 101 stops outputting the signal for the activation that has continuously been output to the direction indicator 103.

As described above, according to the present embodiment, the ECU 101 activates the direction indicator 103 for a first time when the vehicle speed is a first vehicle speed, and activates the direction indicator 103 until a second time shorter than the first time elapses when the vehicle speed is a second vehicle speed greater than the first vehicle speed. As a result, it is possible to control the activation time of the direction indicator 103 with a length corresponding to the situation where the vehicle 1 is traveling.

### Modification

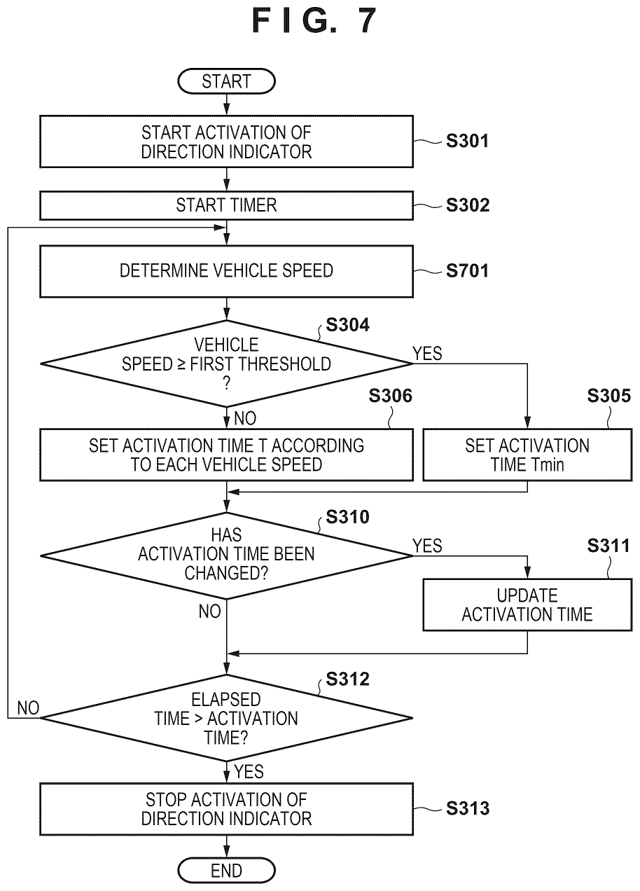

In an example, the ECU 101 may control the activation of the direction indicator 103 based on the vehicle speed without determining the change rate of the vehicle speed. In this case, as illustrated in FIG. 7, the processing in S307 to S309 in FIG. 3 may be omitted, and the processing in S303 in FIG. 3 may be replaced with the processing in S701 for determining only the vehicle speed. Since the processing in S301 to S302, S304 to S306, and S310 to S313 in FIG. 7 is similar to the processing described with reference to FIG. 3, the description thereof will be omitted.

### Summary of Embodiment

1. A control device (101) configured to control activation of a direction indicator (103) provided on a vehicle (1), wherein
the control device is characterized by:
detecting a predetermined signal corresponding to a start of the activation of the direction indicator;
acquiring a value corresponding to a vehicle speed of the vehicle;
activating, when determining that the value corresponds to a first vehicle speed, the direction indicator until a first time elapses after the predetermined signal is detected; and
activating, when determining that the value corresponds to a second vehicle speed greater than the first vehicle speed, the direction indicator until a second time shorter than the first time elapses after the predetermined signal is detected.

As a result, it is possible to appropriately control the activation of the direction indicator according to a situation where the vehicle is traveling.

2. The control device according to the above-described embodiment, wherein when the control device is characterized by controlling, when determining that the value corresponds to a vehicle speed equal to or greater than a third vehicle speed greater than the second vehicle speed, the direction indicator in such a manner that the direction indicator is activated until a third time shorter than the second time elapses after the predetermined signal is detected.

By activating the direction indicator for a plurality of types of activation times according to a situation where the vehicle is traveling, it is possible to appropriately control the activation of the direction indicator.

3. The control device according to the above-described embodiment, wherein the control device is characterized by controlling, when determining that the value corresponds to a vehicle speed less than the third vehicle speed, the direction indicator in such a manner that the direction indicator is activated until a time equal to or greater than the third time elapses after the predetermined signal is detected.

As a result, it is possible to ensure a constant activation time to prevent the activation of the direction indicator from being insufficient even when the vehicle is traveling at a predetermined speed.

4. The control device according to the above-described embodiment, wherein the control device is characterized by controlling, when determining that the value corresponds to a vehicle speed less than a fourth vehicle speed less than the first vehicle speed, the direction indicator in such a manner that the direction indicator does not stop activating after the predetermined signal is detected.

As a result, it is possible to continue the activation of the direction indicator when the vehicle is temporarily stopped and to appropriately control the activation of the direction indicator according to a situation of the vehicle.

5. The control device according to the above-described embodiment, wherein
the control device is characterized by acquiring a value corresponding to a vehicle speed of the vehicle at a predetermined time interval, and
the control device is characterized by stopping, after detecting the predetermined signal, determining that the value corresponds to the first vehicle speed, and starting the activation of the direction indicator and before stopping the activation of the direction indicator and when determining the value corresponds to the second vehicle speed and that the vehicle has accelerated, the activation of the direction indicator according to elapse of a time shorter than the first time.

As a result, it is possible to stop the activation of the direction indicator following the acceleration of the vehicle.

6. The control device according to the above-described embodiment, wherein
the control device is characterized by:
determining a first ratio of the second vehicle speed to the first vehicle speed; and
stopping, when the first ratio is equal to or greater than a first threshold, the activation of the direction indicator according to elapse of a third time shorter than the second time.

As a result, it is possible to terminate the activation of the direction indicator earlier at a time of acceleration to prevent the direction indicator from continuing to activate after a right or left turn of the vehicle 1 is terminated or the like.

7. The control device according to the above-described embodiment, wherein the control device is characterized by stopping, when the first ratio is equal to or greater than a second threshold greater than the first threshold, the activation of the direction indicator when a fourth time shorter than the third time elapses.

As a result, it is possible to terminate the activation of the direction indicator earlier when acceleration is large.

8. The control device according to the above-described embodiment, wherein
the control device is characterized by acquiring a value corresponding to a vehicle speed of the vehicle at a predetermined time interval, and
the control device is characterized by activating, after detecting the predetermined signal, determining that the value corresponds to the second vehicle speed, and starting the activation of the direction indicator and before stopping the activation of the direction indicator and when determining that the value corresponds to the first vehicle speed and that the vehicle has decelerated, the direction indicator for a time longer than the second time.

As a result, it is possible to control the activation time of the direction indicator following the deceleration of the vehicle.

9. The control device according to the above-described embodiment, wherein
the control device is characterized by:
determining a second ratio of the first vehicle speed to the second vehicle speed; and
activating, when the second ratio is equal to or less than a third threshold, the direction indicator until a fifth time longer than the first time elapses.

As a result, it is possible to activate the direction indicator longer when deceleration is small.

10. The control device according to the above-described embodiment, wherein
the control device is characterized by activating, when the second ratio is equal to or less than a fourth threshold less than the third threshold, the direction indicator until a sixth time longer than the fifth time elapses.

As a result, it is possible to activate the direction indicator longer when deceleration is small.

11. The control device according to the above-described embodiment, wherein the control device is characterized by acquiring the value from a speed sensor (102) that measures the number of wheel rotations of the vehicle.

As a result, it is possible to determine the vehicle speed with high accuracy.

12. The control device according to the above-described embodiment, wherein the control device is characterized by controlling the direction indicator via a relay element.

As a result, it is possible to appropriately control, via the relay element, the activation of the direction indicator according to a situation where the vehicle is traveling.

13. Avehicle (1) comprising:
a direction indicator (103); and
a control device, wherein
the control device is characterized by:
detecting a predetermined signal corresponding to a start of activation of the direction indicator;
acquiring a value corresponding to a vehicle speed of the vehicle;
activating, when determining that the value corresponds to a first vehicle speed, the direction indicator until a first time elapses after the predetermined signal is detected; and
activating, when determining that the value corresponds to a second vehicle speed greater than the first vehicle speed, the direction indicator until a second time shorter than the first time elapses after the predetermined signal is detected.

As a result, it is possible to appropriately control the activation of the direction indicator according to a situation where the vehicle is traveling.

14. A control method of a control device (100) configured to control activation of a direction indicator (103) provided on a vehicle (1), the control method is characterized by comprising:
detecting a predetermined signal corresponding to a start of the activation of the direction indicator;
acquiring a value corresponding to a vehicle speed of the vehicle (S303);
activating, when determining that the value corresponds to a first vehicle speed, the direction indicator until a first time elapses after the predetermined signal is detected; and
activating, when determining that the value corresponds to a second vehicle speed greater than the first vehicle speed, the direction indicator until a second time shorter than the first time elapses after the predetermined signal is detected.

As a result, it is possible to appropriately control the activation of the direction indicator according to a situation where the vehicle is traveling.

15. A control device configured to control activation of a direction indicator provided on a vehicle according to a value corresponding to a vehicle speed of the vehicle, wherein
the control device is characterized by:
activating, when the vehicle speed of the vehicle is a first vehicle speed, the direction indicator until a first time elapses; and
activating, when the vehicle speed of the vehicle is a second vehicle speed greater than the first vehicle speed, the direction indicator until a second time shorter than the first time elapses.

As a result, it is possible to appropriately control the activation of the direction indicator according to a situation where the vehicle is traveling.

16. A control device configured to control activation of a direction indicator provided on a vehicle according to a value corresponding to a vehicle speed of the vehicle, wherein
the control device is characterized by:
activating, when the vehicle speed of the vehicle is a first vehicle speed, the direction indicator until a first time elapses; and
activating, when the vehicle speed of the vehicle is a second vehicle speed greater than the first vehicle speed, the direction indicator until a second time shorter than the first time elapses.

As a result, it is possible to terminate the activation of the direction indicator earlier at a time of acceleration to prevent the direction indicator from continuing to activate after a right or left turn of the vehicle 1 is terminated or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A control device configured to control activation of a direction indicator provided on a vehicle, wherein
the control device performs:
detecting a predetermined signal corresponding to a start of the activation of the direction indicator;
acquiring a value corresponding to a vehicle speed of the vehicle at a predetermined time interval;
activating, after determining that the value corresponds to a first vehicle speed and detecting the predetermined signal, the direction indicator until a first time elapses; and
activating, when determining that the value corresponds to a second vehicle speed greater than the first vehicle speed, the direction indicator until a second time shorter than the first time elapses after the predetermined signal is detected,
after detecting the predetermined signal, determining that the value corresponds to the first vehicle speed, and starting the activation of the direction indicator and before stopping the activation of the direction indicator and when determining the value corresponds to the second vehicle speed and that the vehicle has accelerated,
determining a first ratio of the second vehicle speed to the first vehicle speed,
stopping, when the first ratio is equal to or greater than a first threshold, the activation of the direction indicator according to elapse of a third time shorter than the second time,
stopping, when the first ratio is equal to or greater than a second threshold greater than the first threshold, the activation of the direction indicator when a fourth time shorter than the third time elapses.

2. The control device according to claim 1, wherein when the control device controls, when determining that the value corresponds to a vehicle speed equal to or greater than a third vehicle speed greater than the second vehicle speed, the direction indicator in such a manner that the direction indicator is activated until a third time shorter than the second time elapses after the predetermined signal is detected.

3. The control device according to claim 2, wherein the control device controls, when determining that the value corresponds to a vehicle speed less than the third vehicle speed, the direction indicator in such a manner that the direction indicator is activated until a time equal to or greater than the third time elapses after the predetermined signal is detected.

4. The control device according to claim 1, wherein the control device controls, when determining that the value corresponds to a vehicle speed less than a fourth vehicle speed less than the first vehicle speed, the direction indicator in such a manner that the direction indicator does not stop activating after the predetermined signal is detected.

5. The control device according to claim 1, wherein
the control device acquires a value corresponding to a vehicle speed of the vehicle at a predetermined time interval, and
the control device activates, after detecting the predetermined signal, determining that the value corresponds to the second vehicle speed, and starting the activation of the direction indicator and before stopping the activation of the direction indicator and when determining that the value corresponds to the first vehicle speed and that the vehicle has decelerated, the direction indicator for a time longer than the second time.

6. The control device according to claim 5, wherein
the control device performs:
determining a second ratio of the first vehicle speed to the second vehicle speed; and
activating, when the second ratio is equal to or less than a third threshold, the direction indicator until a fifth time longer than the first time elapses.

7. The control device according to claim 6, wherein
the control device activates, when the second ratio is equal to or less than a fourth threshold less than the third threshold, the direction indicator until a sixth time longer than the fifth time elapses.

8. The control device according to claim 1, wherein the control device acquires the value from a speed sensor that measures the number of wheel rotations of the vehicle.

9. The control device according to claim 1, wherein the control device controls the direction indicator via a relay element.

10. A vehicle comprising:
a direction indicator; and
a control device, wherein
the control device performs:
detecting a predetermined signal corresponding to a start of activation of the direction indicator;
acquiring a value corresponding to a vehicle speed of the vehicle at a predetermined time interval;
activating, when determining that the value corresponds to a first vehicle speed, the direction indicator until a first time elapses after the predetermined signal is detected; and
activating, when determining that the value corresponds to a second vehicle speed greater than the first vehicle speed, the direction indicator until a second time shorter than the first time elapses after the predetermined signal is detected,
after detecting the predetermined signal, determining that the value corresponds to the first vehicle speed, and starting the activation of the direction indicator and before stopping the activation of the direction indicator and when determining the value corresponds to the second vehicle speed and that the vehicle has accelerated,
determining a first ratio of the second vehicle speed to the first vehicle speed,
stopping, when the first ratio is equal to or greater than a first threshold, the activation of the direction indicator according to elapse of a third time shorter than the second time,
stopping, when the first ratio is equal to or greater than a second threshold greater than the first threshold, the activation of the direction indicator when a fourth time shorter than the third time elapses.

11. A control method of a control device configured to control activation of a direction indicator provided on a vehicle, the control method comprising:
detecting a predetermined signal corresponding to a start of the activation of the direction indicator;
acquiring a value corresponding to a vehicle speed of the vehicle at a predetermined time interval;
activating, when determining that the value corresponds to a first vehicle speed, the direction indicator until a first time elapses after the predetermined signal is detected; and
activating, when determining that the value corresponds to a second vehicle speed greater than the first vehicle speed, the direction indicator until a second time shorter than the first time elapses after the predetermined signal is detected,
after detecting the predetermined signal, determining that the value corresponds to the first vehicle speed, and starting the activation of the direction indicator and before stopping the activation of the direction indicator and when determining the value corresponds to the second vehicle speed and that the vehicle has accelerated,
determining a first ratio of the second vehicle speed to the first vehicle speed,
stopping, when the first ratio is equal to or greater than a first threshold, the activation of the direction indicator according to elapse of a third time shorter than the second time,
stopping, when the first ratio is equal to or greater than a second threshold greater than the first threshold, the activation of the direction indicator when a fourth time shorter than the third time elapses.

12. A control device configured to control activation of a direction indicator provided on a vehicle according to a value corresponding to a vehicle speed of the vehicle acquired at a predetermined time interval, wherein
the control device performs:
activating, when the vehicle speed of the vehicle is a first vehicle speed, the direction indicator until a first time elapses; and
activating, when the vehicle speed of the vehicle is a second vehicle speed greater than the first vehicle speed, the direction indicator until a second time shorter than the first time elapses,
after detecting the predetermined signal, determining that the value corresponds to the first vehicle speed, and starting the activation of the direction indicator and before stopping the activation of the direction indicator and when determining the value corresponds to the second vehicle speed and that the vehicle has accelerated,
determining a first ratio of the second vehicle speed to the first vehicle speed,
stopping, when the first ratio is equal to or greater than a first threshold, the activation of the direction indicator according to elapse of a third time shorter than the second time,
stopping, when the first ratio is equal to or greater than a second threshold greater than the first threshold, the activation of the direction indicator when a fourth time shorter than the third time elapses.
